(19) United States
(12) Patent Application Publication
(10) Pub. No.: US 2007/0220532 A1
(43) Pub. Date: Sep. 20, 2007

(54) Device for Reading and/or Writing to Optical Recording Media

(76) Inventors: Reiner Baas, Steinbach (DE); Guenter Tabor, Villingen-Schwenningen (DE); Rolf Dupper, Villingen-Schwenningen (DE)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/578,461

(22) PCT Filed: Mar. 16, 2005
(86) PCT No.: PCT/EP05/51224

§ 371 Date: Oct. 16, 2006

(30) Foreign Application Priority Data
Apr. 15, 2004 (EP) 04008970.8

(51) Int. Cl. G11B 17/00

(52) U.S. Cl. 720/607

(57) ABSTRACT

The present invention relates to a device for reading and/or writing to optical recording media having an optical path formed from optical elements, a focusing lens arranged in a lens holder, and a suspension for the lens holder. It is an object of the invention to develop a device of this type. According to the invention, it is provided for this purpose that the suspension of the lens holder is arranged immovably on a base body having a first bearing surface, on which the optical path rests by means of a second bearing surface.

The present invention relates to a device for reading and/or writing to optical recording media such as CD or DVD, for example. The device has an optical path formed from optical elements such as laser diode, beam splitter, lenses, detectors, etc., a focusing lens arranged in a lens holder, and a moveable suspension for the lens holder. In the case of a device of this type, the suspension is arranged in adjustable fashion relative to a baseplate that is fixedly connected to the optical path.

Devices for reading optical recording media are disclosed for example in EP 1 205 920, EP 1 160 780, EP 0 649 130, or EP 0 341 936. In all of these known devices, the actuator with suspension for the lens holder is adjusted with respect to the baseplate. By contrast, the optical path is fixedly connected to the baseplate.

It is an object of the invention to develop a device of this type.

According to the invention, it is provided for this purpose that the suspension of the lens holder is arranged immovably on a base body having a first bearing surface, on which the optical path rests by means of a second bearing surface. This has the advantage that the optical path can now be adjusted relative to the base body. Since only the optical path requires great precision, in this arrangement fewer high-quality materials are used for base body and suspension. In this way, the device according to the invention can be produced more cost-effectively. A separate mounting of the suspension and also a test thereof are now no longer required, which likewise simplifies production.

The invention provides for the bearing surfaces to be spherical surfaces. This has the advantage that this provides the necessary degrees of freedom for adjustment and nevertheless enables a large contact area which keeps the relative position of the two parts as free from vibration as possible when the parts are fixed with respect to one another, and which is for example advantageously used for fixing by means of an adhesive. In this case, the spherical surfaces advantageously have the same radii or radii that deviate only slightly from one another. Identical radii are metrologically simple to handle and are therefore advantageous. In the case of radii that are only slightly different, only a linear or punctiform bearing occurs rather than an areal bearing. Other bearing possibilities such as three-point, a hybrid form of ball, point or multipoint bearing are also advantageously possible. The sole condition that must be met is a rotatable/pivotable bearing.

In an advantageous manner, the optical path has, apart from the focusing lens, all of the optical elements of the scanner of the device according to the invention. This has the advantage that only this component requires the use of high-precision materials and an optically exactly adjusted mounting. Since the elements that require an exact adjustment are united in a small space, they can also advantageously be produced in a separate production step with a higher quality requirement. All that is needed subsequently is an exact adjustment on the base body.

The optical path advantageously has three adjusting surfaces which are acted on by an adjusting apparatus for adjustment during mounting. The adjusting surfaces or the elements whose surface they form are connected, in particular adhesively bonded, to the base body. This has the advantage of simple adjustment and at the same time enables an adhesive-bonding connection for fixing the optical path to the base body.

The optical path is advantageously arranged in a housing. This affords both mechanical protection and dust protection and prevent laser light from emerging or ambient light from impinging.

The invention provides for the base body to be embodied as one piece with one or more of the elements magnet holders, suspension wire holder, guide fork and guide bush of the device. This has the advantage that these components, which for the most part have been separate hitherto, are embodied in one piece, their mounting is thus obviated, and they are already correctly oriented relative to one another from production on.

Further advantages of the invention can be gathered from the following description of an exemplary embodiment. In the figures:

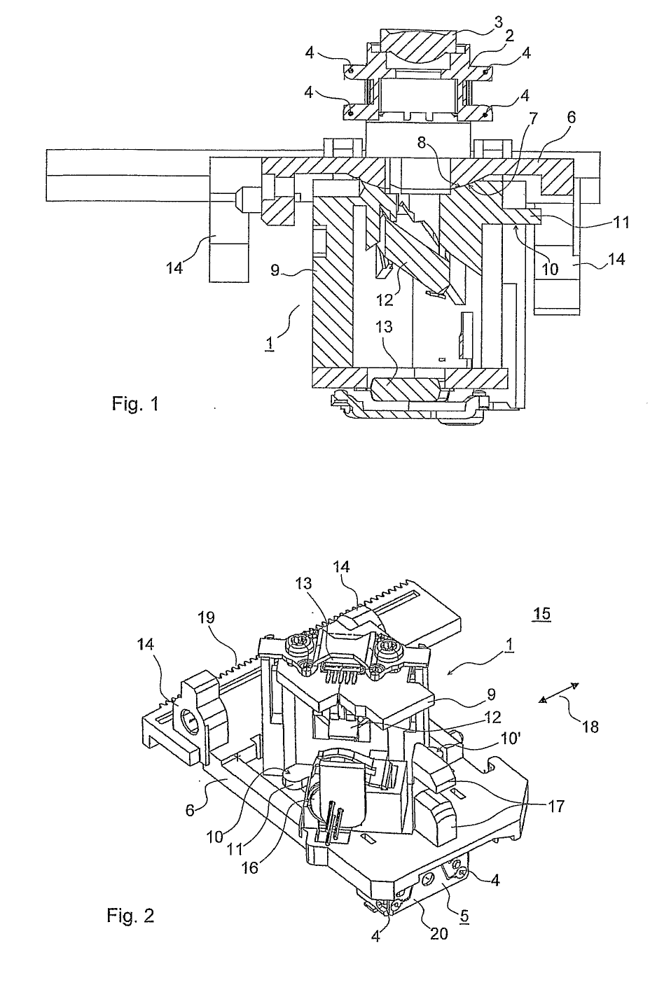

FIG. 1 shows an optical path and lens holder according to the invention in a sectional illustration;

FIG. 2 shows an optical path and base body according to the invention in a three-dimensional illustration;

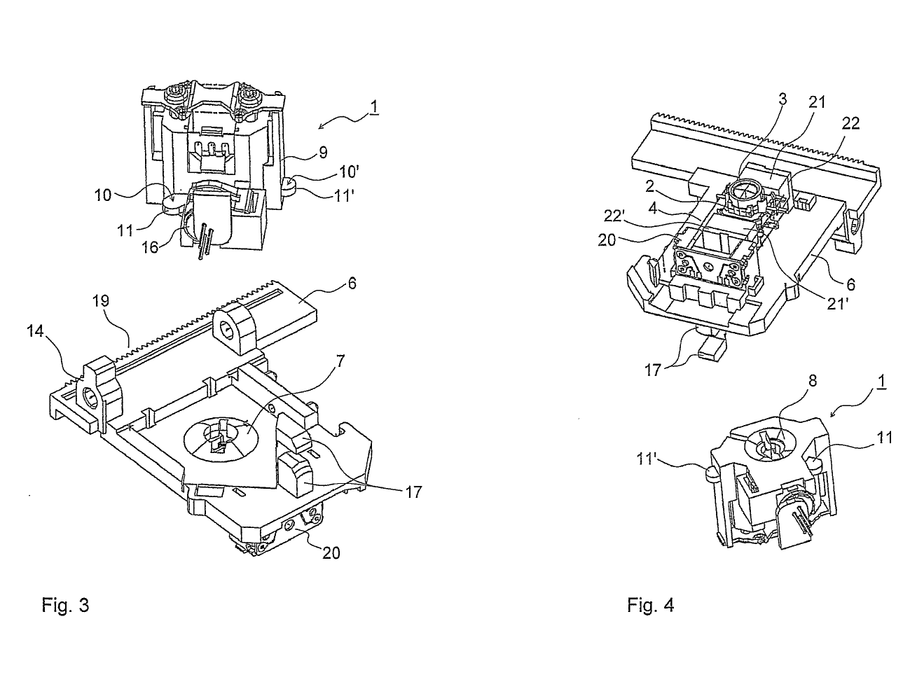

FIG. 3, FIG. 4 show an exploded illustration of optical path and base body.

FIG. 1 shows the optical path 1 and the lens holder 2 of a device according to the invention in a sectional illustration. A focusing lens 3 is arranged on the lens holder 2. The lens holder 2 is connected to the suspension 5 (not visible here) by four suspension wires 4. Said suspension is connected immovably to the base body 6. The base body 6 has a spherical bearing surface 7, which interacts with a likewise spherical bearing surface 8 of a housing 9 of the optical path. One of the adjusting surfaces 10 can likewise be seen, said adjusting surfaces being arranged on adjusting lugs 11 which, for their part, can be connected to the base body 6 by means of adhesive bonding during mounting. A semitransparent mirror 12 and a photo-detector 13 can be discerned as further optical elements in this sectional illustration. The bearing surfaces 7, 8 make it possible to adjust the optical path 1 relative to the base body 6 and thus relative to the focusing lens 3 that is connected immovably to the latter. Furthermore, guide bushes 14 and other elements that will not be described in this illustration are embodied in one piece on the base body 6.

FIG. 2 shows the optical path 1 and the base body 6 of a device according to the invention in a three-dimensional illustration. In this case, these elements which form the optical scanner 15 of the device are illustrated such that an optical recording medium (not illustrated here) would have to be illustrated below the optical scanner 15 in the figure. On the housing 9 it is possible to discern the photodetector 13 and also the laser diode 16 and one of the adjusting lugs 11 with adjusting surface 10. Two further adjusting lugs are not discernable or can only be partly discerned here; only one further adjusting surface 10′ is unconcealed. The position of the semitransparent mirror 12 can also be seen, at which, as an alternative, a polarizing or nonpolarizing beam splitter may be arranged. On the base body 6, it is possible to discern the guide bushes 14 and also a guide fork 17. The guide bushes 14 run along a guide rod that is not illustrated here, while the guide fork 17 engages around a further suitable guide element, e.g. a guide rod or a guide plate. The optical scanner 15 is thus arranged moveably in the direction of the double arrow 18. A toothed rack 19, which in this case is likewise embodied in one piece with the base body 6, serves for drive purposes. The suspension 5 situated below the base body 6 can additionally be discerned right at the bottom. It is likewise possible to see only a part of the suspension wire holder 20, in which suspension wires 4 are fixed.

FIG. 3 shows an exploded illustration of the optical path 1 and base body 6 in the same view as in FIG. 2. Identical parts are provided with identical reference symbols and are explained only insofar as is necessary. On the housing 9, it is now possible to discern two adjusting lugs 11, 11′ with associated adjusting surfaces 10, 10′. The first bearing surface 7 can be seen on the base body 6. It is possible to discern its spherical curvature and a central opening through which the scanning beam coming from the optical path passes to the focusing lens 3 (not visible here).

FIG. 4 shows the same exploded illustration as FIG. 3, but from the opposite direction. On the base body 6, it is now clearly possible to see the suspension wire holder 20 and also the focusing lens 3 arranged in the lens holder 2. The lens holder 2 is connected to the suspension wire holder 20 by means of suspension wires 4. These form the suspension of the lens holder 2. Magnets 21, 21′ held by magnet holders 22, 22′ are arranged on both sides of the lens holder 2. Said magnet holders are connected to the base body 6 in one piece. On the optical path 1, it is possible to discern the second bearing surface 8 as a hollow-spherical recess.

In conventional optical drives, the focusing lens 3 is usually oriented according to the optical path 1. The focusing lens 3 is part of the actuator comprising, inter alia, the magnets 21, 21′, the magnet holders 22, 22′, the lens holder 2, the suspension wires 4 and the suspension 5. Consequently, this orientation is effected by pivoting the actuator. However, this solution approach affords hardly any possibilities for achieving a cost saving by omitting components. Since the optical path also conventionally contains the guide bushes 14, it is also always necessary to adjust the actuator. Moreover, the optical path, which is conventionally connected immovably with the base body 6, has to be produced in a high-quality material even though only certain locations require this precision.

By expediently shrinking the optical path 1 to the size that is only actually required, the invention makes it possible to pivot the optical path 1 with respect to the focusing lens 3. The remaining part is produced in a less expensive material, components such as e.g. the suspension wire holder 20 can be integrated, and others are even obviated, such as e.g. an actuator plate. Consequently, a cost-effective solution is obtained according to the invention.

In other words, the idea of this invention is to replace the adjustment of the focusing lens 3 with respect to the optical path 1 by an adjustment of the optical path 1 relative to the focusing lens 3. The optical path 1 is accommodated in a smaller separate housing 9 embodied e.g. from diecast zinc or a high-quality plastic in order thus to achieve the required precision. The remaining part, including the guide bushes 14, is then produced from a more cost-effective material. Components such as the magnet holder 22 and also the suspension wire holder are integrated.

Since the optical path 1 is accommodated separately in a smaller separate housing 9, a modular construction is also made possible.

The invention constitutes a cost-effective solution. Expensive material is used only at those locations where it is actually necessary. The function of a plurality of parts is concomitantly integrated in the base body. 6 produced from more cost-effective material.

1. A device for reading and/or writing to optical recording media having an optical path unit containing, apart from the focusing lens, all of the optical elements of the scanner of the device, a focusing lens arranged in a lens holder, a suspension for the lens holder, and a base body embodied in one piece with one or more of the elements toothed rack and guide means of the device, the base body having a first bearing surface, wherein the suspension of the lens holder is arranged immovably on the base body, on which the optical path unit rests by means of a second bearing surface, and the optical path is arranged as a component which is adjustable relative to the base body.

2. The device as claimed in claim 1, wherein the bearing surfaces are spherical surfaces.

3. The device as claimed in claim 1, wherein the optical path has adjusting surfaces connected to the base body.

4. The device as claimed in claim 1, wherein the optical path is arranged in a housing.

5. The device as claimed in claim 1, wherein the base body is embodied in one piece with one or more of the elements magnet holders, suspension wire holder, guide fork and guide bush of the device.

6. The device as claimed in claim 1, wherein the optical path contains, apart from the focusing lens, all of the optical elements of the scanner of the device.

7. The device as claimed in claim 6, wherein the optical path has adjusting surfaces connected to the base body.

8. The device as claimed in claim 7, wherein the optical path is arranged in a housing.

9. The device as claimed in claim 8, wherein the base body is embodied in one piece with one or more of the elements magnet holders, suspension wire holder, guide fork and guide bush of the device.

10. The device as claimed in claim 1, wherein the optical path has adjusting surfaces connected to the base body.

11. The device as claimed in claim 10, wherein the optical path is arranged in a housing.

12. The device as claimed in claim 11, wherein the base body is embodied in one piece with one or more of the elements magnet holders, suspension wire holder, guide fork and guide bush of the device.

13. The device as claimed in claim 1, wherein the optical path is arranged in a housing.

14. The device as claimed in claim 13, wherein the base body is embodied in one piece with one or more of the elements magnet holders, suspension wire holder, guide fork and guide bush of the device.

15. The device as claimed in claim 1, wherein the base body is embodied in one piece with one or more of the elements magnet holders, suspension wire holder, guide fork and guide bush of the device.
